(19) United States
(12) Patent Application Publication
(10) Pub. No.: US 2008/0164698 A1
(43) Pub. Date: Jul. 10, 2008

(54) Method and device to measure, test and monitor turbine performance and conditions

(76) Inventor: Gilbert Habets, Voorschoten (NL)

Correspondence Address: Gilbert LGM Habets, Wagenerf 2, Voorschoten, 2251 CR, omitted

(21) Appl. No.: 11/727,304

(22) Filed: Mar. 26, 2007

(30) Foreign Application Priority Data
Jan. 10, 2007 (NL) P28573EP00/CHO

(51) Int. Cl. H02P 9/00; G01L 3/00; G01L 3/26; G01N 11/00

(52) U.S. Cl. 290/44; 290/43; 73/53.01; 73/862.08

(57) ABSTRACT

The present invention relates to a method and a device to measure reliably and accurately a set of data needed to test, operate and monitor the performance of turbines. The invention proposes to determine the performance parameters of a turbine applicable to its entire operating envelope and for a condition when it is producing net output power, by merely measuring its characteristic performance parameters only in the mode of no net output-power production. In the method the performance response of a turbine under no-load conditions and/or no-speed conditions is measured when subject to known values of input for flow, head, hydraulic energy and fluid properties. From this the condition and the performance of the turbine can be determined. Furthermore it is possible to determine best efficiency point for operating the turbine from the recorded no-load and no-speed characteristic.

The present invention relates to a method and a device to measure (reliably and accurately) a set of data needed to test, operate and monitor the performance of turbines. The method according to the invention is applicable to all types of turbines that are energised by a fluid flow at the entry and which convert the energy from this entry flow into rotational energy that can be utilised from the shaft.

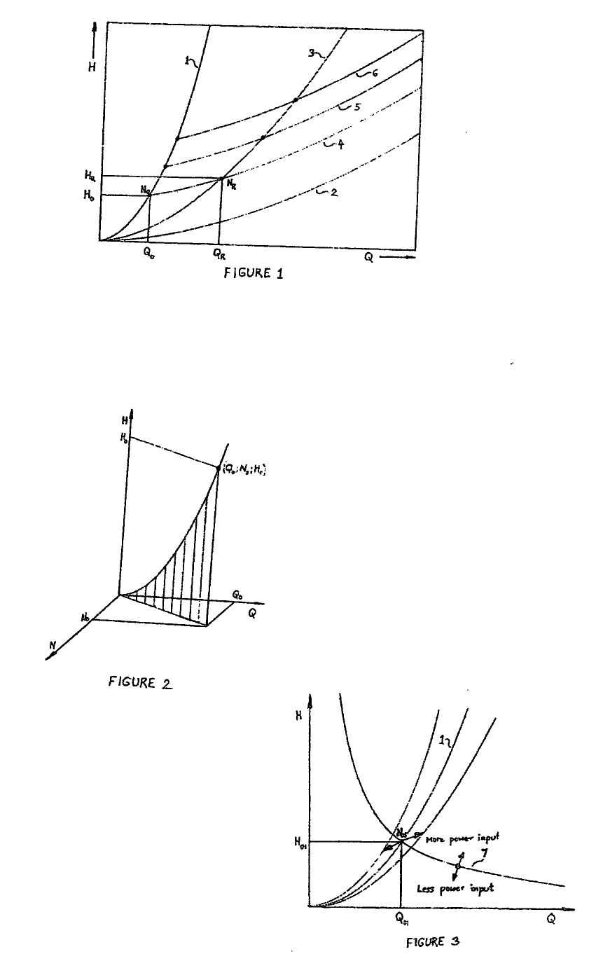

FIG. 1 shows the performance characteristic of a typical hydraulic turbine operating at variable speed. The performance map consists of various performance curves depicting the relationship between head H, flow Q and rotational speed N of the turbine.

The horizontal axis shows the value for Q and the vertical axis shows the values for H.

In case of incompressible liquids, Q is the symbol for the volumetric flow in cubic-meters per hours and H is the symbol for the differential head in meters.

In case of compressible fluids, particularly liquid-vapour mixtures, Q is the symbol for the mass flow in kilogram per second and H is the pressure difference in Megapascal between the turbine inlet and outlet.

The no-load characteristic 1 is the boundary line of the turbine performance envelope corresponding with a no-load condition of the turbine in the low flow area. In this condition the turbine produces no net output and all hydraulic input energy is utilised to spin the turbine at a certain speed with corresponding losses.

The no-speed characteristic 2 is the boundary line of the turbine performance envelope corresponding with a non-rotating condition of the turbine. In this condition the turbine is at standstill and operating like an orifice.

Along the characteristic 1 the turbine is producing no net output torque and therefore no net power. Along the characteristic 2 the turbine produces maximum torque but no power due to rotational speed equal to zero. The turbine operational field is bounded between 1 and 2, and along the best-efficiency characteristic 3 the maximum efficiency defined as power output over power input is achieved.

The typical performance lines 4, 5, 6 at constant speeds are approximately parallel to each other and to the no-speed characteristic 2. With increasing speed the constant speed curves 4, 5, 6 move to higher head values.

The best efficiency characteristic 3 intersects with each constant speed curve 4, 5, 6 at a corresponding intersection point. This point is the best efficiency point for a certain speed. Each of these points has a certain flow Q, head H and speed N that is called rated flow Q_{R}, rated head H_{R} and rated speed N_{R}, since the rated point is generally also the best efficiency point.

The no-load characteristic 1 intersects with each constant speed curve 4, 5, 6 at another corresponding intersection point. Each of these points has a certain flow Q, head H and speed N, which is called no-load flow Q₀, no-load head H₀ and no-load speed N₀.

The present invention is based on the insight that the mechanical and geometrical design of the turbine and thermo-physical properties of the fluid determine the shape of the characteristics 1 and 2. Both characteristics 1 and 2 determine the shape of the best-efficiency characteristic 3.

One aspect of the invention relates to a method for determining the performance of a turbine according to claim 1.

Another aspect of the invention relates to a method for determining the best efficiency flow for operating a hydraulic turbine according to claim 6.

Still another aspect of the invention relates to a method for detecting a two phase fluid in an operating turbine according to claim 8.

Yet another aspect of the invention relates to a turbine system according to claim 13.

The present invention proposes to determine the performance parameters of a turbine applicable to its entire operating envelope and for a condition when it is producing net output power, by merely measuring its characteristic performance parameters only in the mode of no net output-power production.

In the method the performance response of a turbine under no-load conditions and/or no-speed conditions is measured when subject to known values of input for flow, head, hydraulic energy and fluid properties.

It is important to notice that both the no-load characteristic 1 and no-speed characteristic 2 are measured and recorded during the operational mode without any power production or without energized electric generator, they both determine the best-efficiency characteristic 3 for which the power is produced with best efficiency. Therefore, any change in the shape of 1 or/and 2 has a direct effect on the shape of 3 and on the complete operational performance.

This means that before a turbine is operating in an energised mode, i.e. it delivers net energy at the shaft, its characteristics can be fully defined. For a turbine that is installed in an industrial or domestic or utility application and which has been subject to a maintenance overhaul the performance can be verified before it is put back in service again without having to energise it first.

Another preferable option is regular verification of the performance characteristic of turbines or variations thereof, which can be executed at any time intervals without having to remove the turbine from its installed position, but by merely operating it a no-load condition.

In a preferred embodiment the invention also proposes to measure and to record the no-load characteristic and/or no-speed characteristic of turbines that are operating in the field at certain time intervals and to compare these to previous characteristics. Any variation of these characteristics is a direct measure for the internal condition of a hydraulic turbine and will eliminate the need to disassemble a turbine and visually inspect its internals at regular intervals to assess its condition.

The measurement and recordal of the no-load and/or no-speed characteristic of a turbine operating in the field can be performed by a dedicated unit, a performance and monitoring unit. The unit performs data collection, data analysis and calculation. The monitoring unit for monitoring the performance and condition of the turbine is preferably integrated in the turbine control unit.

The concept of the present invention provides a true and reliable on-line performance and condition assessment of turbines resulting in significant operating and maintenance cost reductions.

The application of the methods according to the invention includes, but is not limited to, all types of turbines in water and any fluid power turbines, wind power turbines, gas expanders and turbo expanders.

The application of the invention can be extended to include, but is not limited to, all types of rotating equipment that are being energised from a fluid flow that results in a torque from its shaft. The characteristics measured are specific signatures and are a measure of its performance.

In practise turbines, e.g., cryogenic turbines, can have the generator usually integrated with the turbine shaft, i.e. no separate coupling in between. For those units the no load characteristic for the entire turbine/generator shaft train assembly will be measured as if it is one unit. I.e. losses will be a composite of both generator/turbine. For those turbines with separate shaft couplings, the coupling can be disconnected, this will give no-load characteristic of turbine pure. However coupling can remain connected and than the entire train is measured as if one unit.

The invention also relates to a device for measuring a shaft torque for determining a no-speed characteristic of a turbine according to claim 9 or 12.

The invention will become more apparent from the following description with reference to the drawing, in which:

FIG. 1 shows a performance characteristic of a typical hydraulic turbine operating at variable speed,

FIG. 2 shows a typical example of a no-load characteristic in three dimensions,

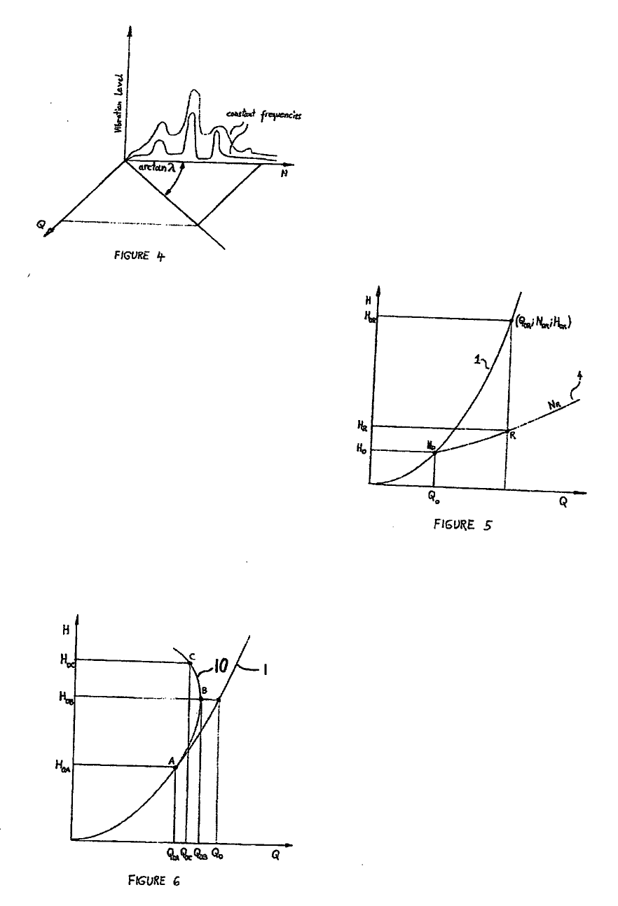

FIG. 3 shows the no-load characteristic of FIG. 2 in two dimensions (no-load flow and no-load head) with an intersecting power input curve,

FIG. 4 shows a no-load characteristic for the relation between no-load speed and no-load flow,

FIG. 5 illustrates the best efficiency point of the hydraulic turbine with respect to the no-load characteristic,

FIG. 6 shows a no-load characteristic in two dimensions (no-load mass flow vs. no-load head) for two phase fluids and for a single phase liquid,

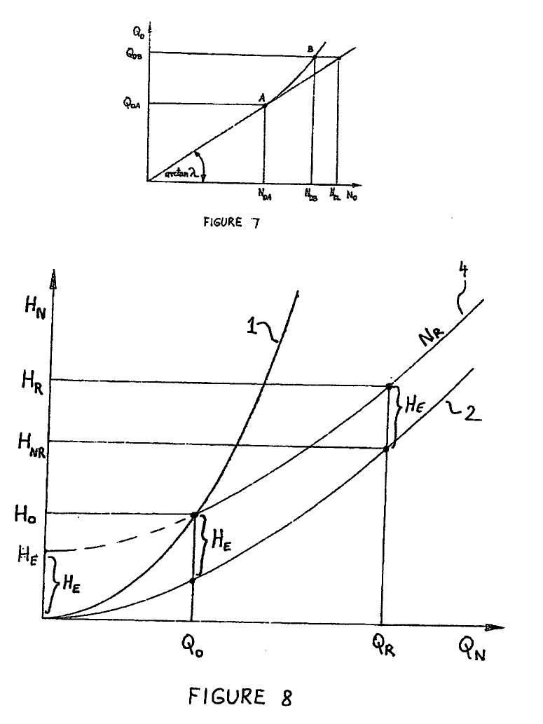

FIG. 7 shows a no-load characteristic in two dimensions (no-load mass flow vs. no-load turbine speed) for two phase fluids and for a single phase liquid,

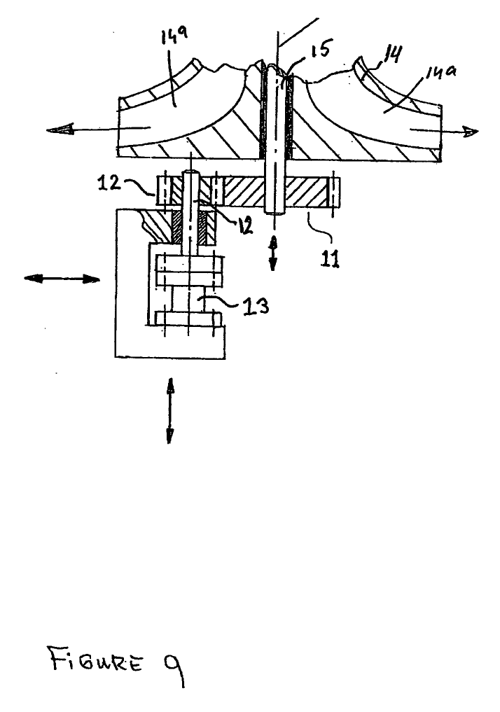

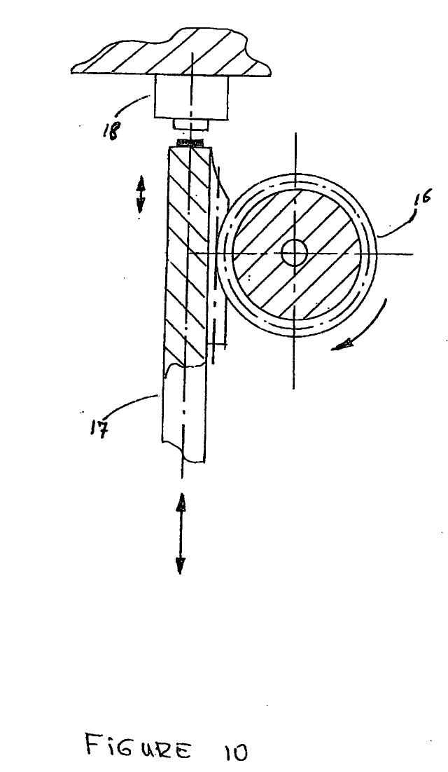

FIG. 8 illustrates the determination of a rated head by means of a no-load characteristic and a no-speed characteristic of the turbine,

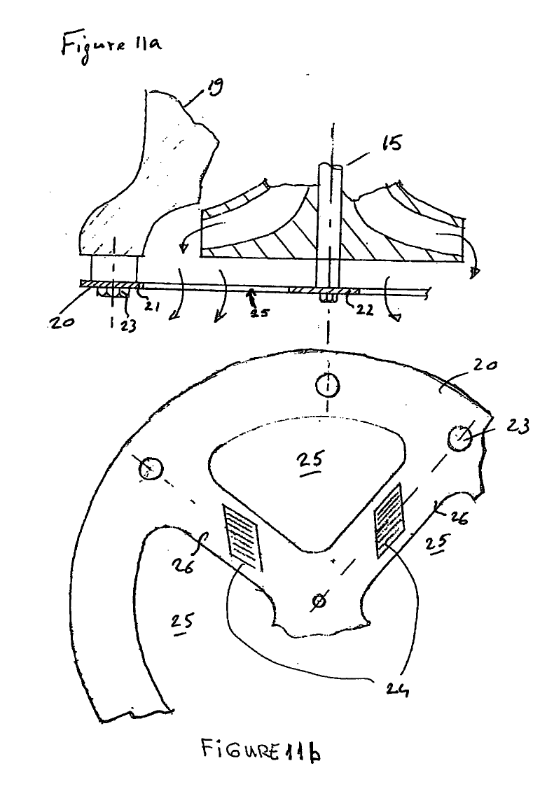

FIG. 9 shows a preferred embodiment of a device for measuring a shaft torque for determining a no-speed characteristic of a turbine,

FIG. 10 shows another preferred embodiment of a device for measuring a shaft torque for determining a no-speed characteristic of a turbine,

FIG. 11 shows yet another preferred embodiment of a device for measuring a shaft torque for determining a no-speed characteristic of a turbine,

FIG. 12 shows a schematic representation of a turbine system according to the invention,

FIG. 13 shows another schematic representation of a turbine system according to the invention,

FIG. 14 shows a typical arrangement for a wind turbine,

FIG. 14a shows a detail of FIG. 14, and

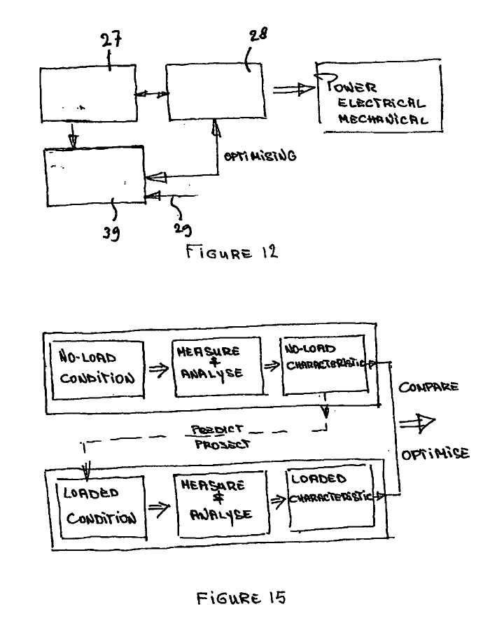

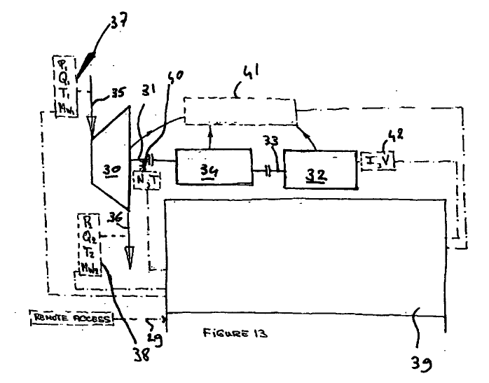

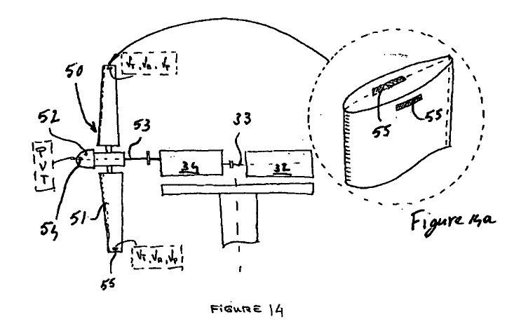

FIG. 15 shows a schematic representation of optimization of operating assets.

The no-load characteristic of a hydraulic turbine is a three-dimensional curve with the axes for no-load flow Q₀, no-load speed N₀ and no-load head H₀.

FIG. 2 shows a typical example of such a no-load characteristic in three dimensions. In the case of incompressible fluids with low viscosity like water, liquefied air, liquefied nitrogen, liquefied oxygen, liquefied carbon dioxide or liquefied natural gas, the no-load head H₀ is proportional to the square of the no-load flow Q₀ and proportional to the square of the no-load speed N₀.

H₀=γQ₀²

H₀=δN₀²

The ratio between no-load flow and no-load speed is constant and equal to λ.

Q₀/N₀=λ

γ, δ and λ are specific no-load constants for the no-load characteristics. By comparing these constants at different times of turbine operation, the condition of the turbine can be determined.

As described, the no-load characteristic produces no net power output and entirely consumes the hydraulic power input to maintain its rotation at certain speeds. The hydraulic power input is proportional to the product of H×Q and the lines of constant input power are hyperbolas.

FIG. 3 shows the no-load characteristic 1 in the two dimensions Q and H. The hyperbolic constant power input curve 7 intersects with the no-load curve at the original no-load point (Q₀₁; N₀₁; H₀₁). If the intersection point of a no-load characteristic corresponding with another condition of the hydraulic turbine for an identical no-load speed N₀ moves to the field above curve 7 then the turbine will consume more power input. This is a direct indication for additional hydraulic or mechanical losses, e.g. additional flow restrictions, potential fouling or blockage of fluid passage ways or rotor rubbing or bearing deterioration. If the new intersection points are below curve 7 then less energy will be consumed. This is a direct indication for a reduction of hydraulic or mechanical losses, e.g. increase of internal or external leaks, increase in openings of the fluid passages or similar. Changes to the hydraulic turbine fluid passage ways due to corrosion, erosion, abrasion or cavitation will alter the no-load characteristic. Such changes will be detected. Pending at what location inside the hydraulic turbine such changes to the fluid passages occur and to what degree and extent, the intersection point corresponding with the altered condition can move either direction.

FIG. 4 shows the no-load characteristic in two dimensions N₀, Q₀. It is a line with the slope λ:

λ=Q₀/N₀

The constant λ depends on the design of the turbine runner and measures the difference between the angular momentum of the fluid at runner inlet and outlet. Which is equal to the torque generated by the turbine. For the no-load characteristic with zero-net output torque, λ is equal to Q₀/N₀. Any change in the slope λ directly indicates a change in the power generation of the turbine.

By measuring the mechanical vibration levels and related frequency spectra of the hydraulic turbine rotor-bearing system for operating conditions corresponding with the no-load curve and comparing these with previously obtained vibration levels and frequency spectra under similar conditions, it becomes possible to accurately detect early indications of deteriorating mechanical conditions of the hydraulic turbine rotor bearing system. Such deteriorations can be detected from changes in the vibration levels and frequency spectra before the turbine is energized and potentially can avoid more serious damage whilst operating under load during which failures and its consequences potentially can have more serious impact on equipment and business costs. Any changes in the vibration levels causes also changes in the input energy since vibrations are mechanical losses and can be detected in the no-load characteristic described in FIG. 3.

FIG. 5 shows the rated point R that is also the best efficiency point of the hydraulic turbine. Euler's turbine equation requires for the best efficiency point R that the angular momentum of the fluid at the hydraulic turbine runner outlet under ideal conditions is equal to zero, which means that the angular exit velocity is zero.

The angular velocity of the fluid at the hydraulic turbine runner inlet under ideal conditions has to be equal to the circumferential or tip speed of the hydraulic turbine runner inlet to avoid fluid entrance losses. With r₁ as the outer radius of the hydraulic turbine runner and r₂ as the inner radius of the hydraulic turbine runner, N_{R} as the rated speed, Q_{R} as the rated flow, N_{0R} as the no-load speed for the no-load flow Q_{0R}=Q_{R}, the angular inlet momentum r₁N_{R} is equal to the angular outlet momentum r₂ (N_{0R}−N_{R}) at the no-load characteristic point (Q_{0R}; N_{0R}; H_{0R}).

r₁N_{R}=r₂(N_{0R}−N_{R})

This condition leads to the relation

N_{0R}/N_{R}=1+r₁/r₂ or N_{0R}=N_{R}(1+r₁/r₂)

The intersection of the rated speed performance characteristic with the no-load characteristic gives the values for the no-load point (Q_{0R}; N_{0R}; H_{0R}) whereas N₀=N_{R} at this point. As described in FIG. 2 it is known that

Q_{R}/Q₀=N_{0R}/N_{R}

By measuring Q₀ and N₀=N_{R} at the no-load characteristic, the value of the best efficiency or rated flow QR can be determined without producing power.

Q_{R}=Q₀(1+r₁/r₂)

This provides the opportunity to operate the hydraulic turbine at a best efficiency point that is determined under no load conditions. It reduces the complexity and costs of hydraulic turbine testing at the manufacturers test stand as no net out put power is produced, whilst best efficiency points for an entire range of operating speeds can be accurately determined via indirect measurements.

It is not possible to determine the corresponding best efficiency or rated head H_{R} with the no-load characteristic. To determine the rated head H_{R} it is necessary to measure and record the no-speed characteristic as well.

The no-speed characteristic as described in FIG. 1 is a curve in the two dimensions Q and H, since the speed N is equal to zero. FIG. 8 shows a typical no-speed characteristic fox incompressible liquids with low viscosity like water or liquefied natural gas.

The values for flow Q and head H for the no-speed characteristic are called Q_{N} and H_{N}. Since the non-rotating turbine is practically like an orifice in the fluid stream, the following relation holds

H_{N}=αQ_{N}²

α is a constant and is the orifice constant of the turbine. The no-speed characteristic can be measured and recorded by locking the rotor with a device that does not permit rotation of the rotor, but permits at most only small axial rotor movements and very small angular movements.

As described in FIG. 1 the constant speed curves 4, 5, 6 are parallel to the no-speed characteristic. By measuring the no-speed characteristic 2 and analyze the data together with the data of the no-load characteristic as in FIG. 5, the best efficiency or rated head H_{R} for the rated flow Q_{R} can be determined.

This can be achieved by moving the no-speed characteristic parallel in the direction of increasing head H to the intersection of the no-load point with the speed N₀=N_{R}.

H_{R} is the head on this shifted no-speed characteristic, which is then equal to the constant rated speed curve.

By measuring the torque generated by the fluid passing through the turbine during locked rotor operation, the torque value T_{N} is proportional to the square of the flow Q_{N}

T_{N}=τQ_{N}²

By knowing the constant τ, it is possible to determine the shaft torque and the shaft power for regular operation of the turbine. Knowing the mechanical shaft power, the electrical power output of the generator and the hydraulic power input, the efficiency of the electrical generator and the efficiency of the turbine can be independently determined.

To measure the torque of a hydraulic turbine at no-speed condition, i.e. when it is at standstill however full hydraulic flow is acting on the turbine, requires a device that prevents rotation, that is locks the shaft, and simultaneously measures the torque from the turbine shaft.

In practise small axial movements of the rotor assembly in order to adjust thrust balancing for different operational conditions can occur It is therefore preferable to have a device, which permits for small axial movement and very small angular movements.

A first preferred embodiment of the device for measuring a shaft torque for determining a no-speed characteristic of a turbine, is shown in FIG. 9. It shows part of a turbine 14 with a flow outlet 14a and a turbine shaft 15. The device comprises a pair of gears 11, 12 for parallel shafts. The large gear wheel 11 is mounted to one end of the turbine shaft 15 and the smaller pinion gear 12 is mounted to a parallel 12a shaft which includes the measuring device.

The shaft 12a with the pinion is connected to an (industrial type) (flanged) reaction torque sensor 13. The pinion shaft 12 permits axial rotor movements of the turbine 14 and measures the torque of the turbine 14 during no-speed operation. With a remotely operated actuator (not shown), the shaft 12a with the pinion 12 and torque sensor 13 can be moved in and out of the large gear wheel 11.

A second embodiment of the device for measuring a shaft torque for determining a no-speed characteristic of a turbine is shown in FIG. 10. It uses a large bull gear 16 engaged with a straight gear rack 17. The gear rack 17 can be engaged with the gear wheel 16 and moved in and out by means of a remotely operated actuator (not shown). During the measurements the torque from the bull gear 16 is transferred to the rack 17 into a linear force and onwards to a load cell 18.

A third embodiment device for measuring a shaft torque for determining a no-speed characteristic of a turbine uses a flat plate 20 with very large openings 25 (FIG. 11) that allow the flow to pass thru without obstructions. This plate 20 will be attached by means of bolts 23 or the like to a turbine casing 19 at the perimeter 21 and to the turbine shaft 15 at a centre portion 22. The openings 25 are defined by the outer portion 21, the centre portion and radially extending spoke-like members 26 connecting the centre portion 22 and the outer portion 21. The plate 20 is provided with strain-gauges 24 provided on the spoke-like members 26 and fully calibrated to measure the tangential deflection at certain pre-determined locations. Calibration is done in a jig whilst submerged in the fluid at temperature that serves as testing medium to have full temperature compensation.

The plate 20 is thin, for example approximately 5 mm thick and preferably made of SS or Al. Its geometry gives it the characteristic of being very stiff in tangential and radial directions, however very flexible in axial direction, wherein the axial direction is the direction perpendicular to the plate surface. Stiffness in the tangential/radial direction and the axial direction will be orders of magnitude difference. This will fix the shaft in radial direction, prevent rotation in a safe manner and present no obstructions to axial movements, e.g. by material expansion and thrust beating movements. It is a calibrated measuring device, without hysteresis, without friction nor obstruction to flow. It will be easy to install prior to a performance test and can be removed afterwards without having to disassemble the turbine. It however requires the turbine to be removed from its installed position.

Turbines are expanding pressurized liquids and in specific cases the expansion process crosses the saturation line of the liquid and the fluid begins partially to vaporize. These partially vaporized fluids are called two-phase fluids. These fluids are actually boiling liquids and generate vapor bubbles. It is difficult to detect two-phase fluids in operating turbines, but it is possible to detect it with method according to one aspect of the invention.

FIG. 6 shows the no-load characteristic for two-phase fluids, also called liquid-vapor fluids. For two-phase fluids the flow Q₀ has to be measured in units of mass per second like kg/s and the differential head H₀ in units of pressure like Pascal. By comparing the no-load characteristics for liquids l with the no-load characteristics for liquid-vapor mixtures 10, it can be determined at which no-load flow Q_{0A} and no-load differential head H_{0A} the liquid begins to boil.

At this beginning boiling point A the slope of the no-load characteristic 10 increases compared to 1, because more input energy is needed to partially vaporize the fluid. The slope of the two-phase no-load characteristic increases with increasing flow and head until it is practically infinite large, or has a vertical tangent line. At this point B the specific volume of the two-phase fluid reaches a maximum value for the specific geometry of the turbine and it is not possible to increase further the mass flow. If more differential head H_{0C} is applied, then the specific volume is further increasing but reduces the mass flow Q_{0C}.

FIG. 7 shows the no-load characteristic for two-phase fluids in comparison with the no-load characteristic for liquids only in two dimensions N₀=speed and Q₀=mass flow. At the point A the slope changes and this is the starting point of two-phase formation.

The specific volume divided by the area of the cross-section at the turbine runner outlet and multiplied by the mass flow is equal to the velocity of the fluid. At the point B this velocity is equal to the speed of sound for the specific two-phase fluid.

By comparing the no-load characteristics for liquid only and for liquid-vapor mixture for the same mass flow Q₀, it shows that the no-load speeds N₀₁ and N_{0B} are not equal. Due to the conservation of angular momentum, the ratio of the no-load speed N₀₁ for liquids and the no-load speed N_{0B} for two-phase fluid are equal to the ratio of the specific densities of the liquid to the two-phase fluid. Therefore the specific density of the two-phase mixture can be determined if the specific density of the liquid is known. The specific volume is reciprocal to the specific density and by knowing the specific volume for the liquid, the specific volume of the two-phase mixture can be determined. From the determined specific volume of the two-phase mixture the percentage of vapor can be calculated and also the speed of sound, as described above.

FIG. 12 shows a schematic diagram of a turbine system. The system comprises a turbine generator train illustrated by a block indicated by reference numeral 27. A performance and condition monitoring unit 39 will collect data from the turbine train 27 and provide specific output to a control unit 28 of the turbine train 27. The performance and monitoring unit 39 has preferably a remote access capability, illustrated by an arrow indicated by reference numeral 29. The remote access capability to permits data transfer to others. The monitoring unit 39 can be integrated as a separate unit in the system as is indicate din FIG. 12. An alternative to a separate monitoring unit 39 is to incorporate the functionality directly into the control unit 28 of the turbine.

The monitoring unit 39 will give the capability to optimise the operation of the turbine train 27 and thereby the power delivered either as electrical power or mechanical power or hydraulic function of the turbine, depending on the turbine train configuration.

FIG. 13 shows a typical arrangement for a turbine system comprising a turbine-generator train. The turbine system comprises a turbine 30 with an output shaft 31. The system further comprises a generator 32 for generating electrical power with an input shaft 33. Between the output shaft 31 of the turbine 30 and the input shaft 33 of the generator 32 a gearbox 34 is arranged.

The turbine 30 has a turbine inlet 35 and a turbine outlet 36. At the turbine inlet 35 is arranged a sensor unit indicated by 37 for measuring the pressure P₁, flow Q₁, temperature T₁ and molecular weight MW₁ of the driving fluid at the inlet 35 of the turbine 30. At the turbine outlet 36 is arranged a set of sensors indicated by 38 for measuring the pressure P₂, flow Q₂, temperature T₂ and molecular weight MW₂ of the driving fluid at the outlet 36 of the turbine 30. Thess sensor unit 37 and 38 have a plurality of sensors for measuring the separate parameters.

The sensor units 37 and 38 are connected to a monitoring unit 39 for monitoring the condition and performance of the turbine-generator train for providing signals representing the measured values of the parameters thereto.

At the output shaft 31 of the turbine 30 a sensor unit 40 is arranged for measuring the shaft speed N and the shaft torque T. This sensor unit 40 also can have a plurality of sensors for measuring the separate parameters N and T. The sensor unit 40 is connected to the monitoring unit 39 for providing signals representing the measured parameters thereto.

Preferably, at the shaft 31 and at the generator 32 vibration signals and bearing temperature signals are measured by sensor unit 41 comprising a plurality of sensors for measuring the separate parameters. Preferably, at the generator 32 and control unit the electrical parameters current I and voltage V for all phases combined with phase angles are measured by sensor unit 42. The sensor units 41 and 42 are connected to the monitoring unit 39 for providing signals representing the measured parameters thereto.

The functionality of the monitoring unit 39 includes preferably data collection, data analysis, algorithms to calculate performance and condition characteristics, comparison of characteristics, output to the control unit to optimise operation, data storage and keeping history.

The performance and condition characteristics include quality information on:

Hydraulic performance: pressure, head, flow, hydraulic efficiency;
Thermodynamic performance: pressure, head, temperature, flow, molecular weight, thermodynamic efficiency;
Aerodynamic performance: flow field patterns, fluid velocity at blades, propellers, runners and turbine wheel;
Electrical Performance: currents, voltages, frequency patterns, phase angles;
Mechanical condition: vibration patterns, material stress, shaft torques, shaft speeds, bearing temperatures, auxiliary systems parameters

Determining the characteristic of turbines under no-load conditions by means of a monitoring unit 39 will give a capability for asset management of installations and equipment. Optimising the operation of a turbine train based on real time performance and condition data characteristics obtained at no-load and load conditions will provide a managing capability to: operate at best efficiency points of the turbine train, risk reduction to avoid unexpected failures (maximise reliability), extend operating windows until best opportunity to execute maintenance (maximise availability), protection and safeguarding at high level, reduce operating costs significantly. FIG. 15 shows a scheme with the building blocks for such optimization of operating assets.

FIG. 14 shows a typical arrangement for a wind turbine. It shows a rotor 50 with rotor blades 51, a nacelle 52 and an output shaft 53 which is coupled to a gear box 34. Further the system comprises a generator 32 with an input shaft 33 which is connected to the gear box 34. At the nacelle 52 wind pressure P, temperature T and velocities V are measured by a sensor unit 54.

At one or more of the blade tips sensors 55 are (see FIG. 14a) arranged for measuring blade tip velocity and wind velocities in tangential direction Vₜ, axial direction Vₐ, and peripheral direction Vₚ. The wind turbine can be controlled and monitored by a similar configuration as is indicated in FIG. 12.

1. Method for determining the performance of a turbine, such as a wind, liquid or fluid driven turbine, for an operating mode where the turbine produces net power, characterized by:
measuring one or more characteristic performance parameters, selected from the flow (Q₀, Q_{N}), turbine speed (N₀) and/or head (H₀, H_{N}), of the turbine in an operating mode where the turbine produces no net output power,
determine a no net output power verification characteristic of the turbine
measuring one or more characteristic performance parameters, selected from the flow (Q₀, Q_{N}), turbine speed (N₀) and/or head (H₀, H_{N}), of the turbine in an operating mode where the turbine produces no net output power,
determine a no net output power characteristic of the turbine
compare the determined characteristic to the earlier determined verification characteristic at the operating mode with no net output power production,
determining the condition of the turbine.

2. Method according to claim 1, wherein the performance of the turbine is determined at certain time intervals according to claim 1 so as to monitor the performance of the turbine over time.

3. Method according to claim 1 or 2, wherein the turbine is operated in a no-load condition under known input values for flow, head, hydraulic energy and fluid properties during measurement of the one or more performance parameters.

4. Method according to any one of the preceding claims, wherein the turbine is operated in a no-speed condition while being subjected to known input values for flow, head, hydraulic energy and fluid properties during measurement of the performance parameters.

5. Method according to claim 3, wherein the intersection point between the measured no-load characteristic of the turbine and a constant-power input curve is determined and is compared to the intersection point between an earlier measured no-load characteristic of the turbine and the constant-power input curve so as to determine if hydraulic losses have increased or decreased.

6. Method for determining the best efficiency flow for operating a turbine, such as a wind, liquid or fluid driven turbine, comprising a rotating turbine runner, at a certain turbine speed for a mode where it produces net output power, characterized by
measuring the no-load flow of the turbine in a no-load operating mode for a certain turbine speed,
determine the best efficiency flow for that turbine speed by multiplying the measured no-load flow by (1+r₁/r₂), wherein r₁ is the outer radius of the turbine runner and r₂ is the inner radius of the turbine runner.

7. Method for determining the best efficiency head for operating a turbine, such as a wind, liquid or fluid driven turbine, comprising a rotating turbine runner, at a certain turbine speed for a mode where it produces net output power, wherein:
the best efficiency flow (Q_{R}) is determined according to the steps of claim 6,
a no-load characteristic of the turbine is determined by operating the turbine in a no-load condition while being subjected to known input values for flow, head, hydraulic energy and fluid properties during measurement of the performance parameters and by measuring the no load flow (Q₀) and no load head (H₀) for different no load speeds (N₀)
a no-speed characteristic of the turbine is determined by operating the turbine in a no-speed condition while being subjected to known input values for flow, head, hydraulic energy and fluid properties during measurement of the no-speed flow and no-speed head,
the no-speed characteristic is shifted upward until at the no-load flow (Q₀) for the speed concerned the shifted no-speed characteristic and the no-load characteristic intersect,
determine at the best efficiency flow (Q_{R}) the best efficiency head (H_{R}) for the speed concerned.

8. Method for detecting a two phase fluid in an operating turbine, characterized by
measuring the no-load mass flow of the turbine in an operating mode where the turbine produces no net output power for different no load turbine speeds,
determine a no net output power characteristic of the turbine,
determine at what no-load mass flow and what no load turbine speed the slope of the characteristic increases so as to determine the starting of two phase formation.

9. Device for measuring a shaft torque for determining a no-speed characteristic of a turbine, characterized in that it comprises a gear wheel which is attached to the turbine shaft, and a toothed member which is attached to a force measuring sensor, wherein said gear wheel and the toothed member mutually engage and allow for a slight axial movement of the turbine shaft.

10. Device according to claim 9, wherein the toothed member is a pinion which is attached to a torque measuring sensor.

11. Device according to claim 9, wherein the toothed member is a gear rack which is attached to a load cell.

12. Device for measuring a shaft torque for determining a no-speed characteristic of a turbine, characterized in that it comprises a flat plat with an outer portion and a centre portion which are connected by spoke-like elements which define relatively large openings between them, which plate is attachable at its outer portion to a turbine casing an at its centre portion to the turbine shaft, and wherein strain gauges are provided on the spoke-like elements for measuring a tangential deflection of the spoke-like elements due to a torque applied by the turbin shaft.

13. Turbine system comprising:
a turbine-generator train comprising a turbine driven by a fluid flow, which turbine has an output shaft, and comprising a generator for transforming the output power delivered by the turbine at the output shaft into electrical energy,
a turbine control unit generating control signals for controlling the operation of the turbine-generator train,
measuring means arranged at the turbine for measuring parameters selected from the flow (Q₀, Q_{N}), turbine speed (N₀) and/or head (H₀, H_{N})
a monitoring unit for monitoring the condition and the performance of the turbine-generator train, which monitoring unit is connected to the measuring means and to the control unit,
wherein the monitoring unit comprises a memory in which a no net output power verification characteristic is stored as well as computing means to calculate the no net output power characteristic of the turbine-generator train based on the measured parameters and to compare that characteristic with the verification characteristic so as to determine the performance and condition of the turbine-generator train, and wherein the monitoring unit is adapted to generate one or more signals representative for the performance and condition of the turbine-generator train which are provided to the control unit.
